(19) United States
(12) Patent Application Publication
(10) Pub. No.: US 2007/0076929 A1
(43) Pub. Date: Apr. 5, 2007

(54) System and method for automatic post processing image generation

(75) Inventors: Thomas A. Gentles, Algonquin, IL (US); Ashish D. Vassa, Palatine, IL (US); Vijaykalyan Yeluri, Sunnyvale, CA (US); Denny Wingchung Lau, Sunnyvale, CA (US); Jeffrey Craig Hellinger, San Francisco, CA (US); David Seungwon Paik, Palo Alto, CA (US); Sandy Napel, Menlo Park, CA (US); Robert John Herfkens, Stanford, CA (US)

Correspondence Address: MCANDREWS HELD & MALLOY, LTD, 500 WEST MADISON STREET, SUITE 3400, CHICAGO, IL, 60661, US

(73) Assignee: General Electric Company

(21) Appl. No.: 11/245,270

(22) Filed: Oct. 5, 2005

(51) Int. Cl. G06K 9/00; G06Q 10/00

(52) U.S. Cl. 382/128; 705/2

(57) ABSTRACT

Certain embodiments of the present invention provide a system and method for automatic image post processing in a healthcare environment. In an embodiment, an automatic post processing image generation system includes at least one user interface, which is adapted to display at least one image on an image viewer and perform image post processing using at least one image post processing application. The system also includes at least one storage server capable of storing user data, wherein the user data includes at least one image and/or at least one post processing parameter. In addition, the system includes a post processing engine for automatically generating and displaying a current post processed image based on at least one image registration technique to correlate the at least one post processing parameter of a related previous post processed image with a current image.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to automatic post processing image generation in a healthcare environment. In particular, the present invention relates to a system and method for improving workflow using automatic post processing image generation to improve the efficiency in which a medical practitioner and/or technician is able to view a patient's images based on a patient's images from previous examinations.

A clinical or healthcare environment is a crowded, demanding environment. Thus, a system and method providing improved organization and improved ease of use of imaging systems, data storage systems, and other equipment used in the healthcare environment would be highly desirable. A healthcare environment, such as a hospital or clinic, encompasses a large array of professionals, patients, and equipment. Personnel in a healthcare facility must manage a plurality of patients, systems, and tasks to provide quality service to patients. Healthcare personnel may encounter many difficulties or obstacles in their workflow.

A variety of distractions in a clinical environment may frequently interrupt medical personnel or interfere with job performance. Furthermore, workspaces, such as a radiology workspace, may become cluttered with a variety of monitors, data input devices, data storage devices, and communication devices, for example. Cluttered workspaces may result in inefficient workflow and service to clients, which may impact a patient's health and safety or result in liability for a healthcare facility. Data entry and access is also complicated in a typical healthcare facility.

Thus, management of multiple and disparate devices, positioned within an already crowded environment, that are used to perform daily tasks is difficult for medical or healthcare personnel. Additionally, a lack of interoperability between the devices increases delay and inconvenience associated with the use of multiple devices in a healthcare workflow. The use of multiple devices may also involve managing multiple logons within the same environment.

In a healthcare environment involving extensive interaction with a plurality of devices, such as keyboards, computer mousing devices, imaging probes, and surgical equipment, repetitive motion disorders often occur. A system and method that eliminate some of the repetitive motion in order to minimize repetitive motion injuries would be highly desirable.

Healthcare environments, such as hospitals or clinics, include clinical information systems, such as hospital information systems (HIS) and radiology information systems (RIS), and storage systems, such as picture archiving and communication systems (PACS). Information stored may include patient medical histories, imaging data, test results, diagnosis information, management information, and/or scheduling information, for example. The information may be centrally stored or divided at a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

In current information systems, such as PACS, information is entered or retrieved using a local computer terminal with a keyboard and/or mouse. During a medical procedure or at other times in a medical workflow, physical use of a keyboard, mouse or similar device may be impractical (e.g., in a different room) and/or unsanitary (i.e., a violation of the integrity of an individual's sterile field). Re-sterilizing after using a local computer terminal is often impractical for medical personnel in an operating room, for example, and may discourage medical personnel from accessing medical information systems.

Imaging systems are complicated to configure and to operate. Often, healthcare personnel may be trying to obtain an image of a patient, reference or update patient records or diagnosis, and ordering additional tests or consultation. Thus, there is a need for a system and method that facilitate operation and interoperability of an imaging system and related devices by an operator.

In many situations, an operator of an imaging system may experience difficulty when scanning a patient or other object using an imaging system console. For example, using an imaging system, such as an ultrasound imaging system, for upper and lower extremity exams, compression exams, carotid exams, neo-natal head exams, and portable exams may be difficult with a typical system control console. An operator may not be able to physically reach both the console and a location to be scanned. Additionally, an operator may not be able to adjust a patient being scanned and operate the system at the console simultaneously. An operator may be unable to reach a telephone or a computer terminal to access information or order tests or consultation. Providing an additional operator or assistant to assist with examination may increase cost of the examination and may produce errors or unusable data due to miscommunication between the operator and the assistant.

A reading, such as a radiology or cardiology procedure reading, is a process of a healthcare practitioner, such as a radiologist or a cardiologist, viewing digital images of a patient. The practitioner performs a diagnosis based on a content of the diagnostic images and reports on results electronically (e.g., using dictation or otherwise) or on paper. The practitioner, such as a radiologist or cardiologist, typically uses other tools to perform diagnosis. Some examples of other tools are prior and related prior (historical) exams and their results, laboratory exams (such as blood work), allergies, pathology results, medication, alerts, document images, and other tools. For example, a radiologist or cardiologist typically looks into other systems such as laboratory information, electronic medical records, and healthcare information when reading examination results.

Currently, a practitioner must log on to different systems and search for a patient to retrieve information from the system on that patient. For example, if a patient complains of chest pain, a chest x-ray is taken. Then the radiologist logs on to other systems to search for the patient and look for specific conditions and symptoms for the patient. Thus, the radiologist may be presented with a large amount of information to review.

Depending upon vendors and systems used by a practitioner, practitioners, such as radiologists or cardiologists, have only a few options to reference the tools available. First, a request for information from the available tools may be made in paper form. Second, a practitioner may use different applications, such as a radiologist information system (RIS), picture archiving and communication system (PACS), electronic medical record (EMR), healthcare information system (HIS), and laboratory information system (LIS), to search for patients and examine the information electronically.

In the first case, the practitioner shifts his or her focus away from a reading workstation to search and browse through the paper, which in most cases includes many pieces of paper per patient. This slows down the practitioner and introduces a potential for errors due to the sheer volume of paper. Thus, a system and method that reduce the amount of paper being viewed and arranged by a practitioner would be highly desirable.

In the second case, electronic information systems often do not communicate well across different systems. Therefore, the practitioner must log on to each system separately and search for the patients and exams on each system. Such a tedious task results in significant delays and potential errors. Thus, a system and method that improve communication and interaction between multiple electronic information systems would be highly desirable.

Additionally, even if systems are integrated using mechanisms such as Clinical Context Object Workgroup (CCOW) to provide a practitioner with a uniform patient context in several systems, the practitioner is still provided with too much information to browse through. Too much information from different applications is provided at the same time and slows down the reading and analysis process. There is a need to filter out application components that a user will not need in a routine workflow. Thus, a system and method which manage information provided by multiple systems would be highly desirable.

Furthermore, if a technologist is performing a radiology or cardiology procedure, for example, the technologist typically accesses multiple applications to obtain information prior to the procedure. In a digital environment, information resides in a plurality of disparate systems, such as a RIS and a PACS. Currently, the technologist must access each system and search for the information by clicking many tabs and buttons before having access to all of the information needed to start the procedure. Often, such an effort by a technologist to obtain information for a procedure results in a decrease in productivity due to the time involve and/or a decrease in information quality due to the time involved to do a thorough search. Thus, a system and method which improve searchability and access to data would be highly desirable.

Additionally, referring physicians use many computerized applications for patient care. In radiology, a physician may look at information from RIS, PACS, EMR, and Computer Physician Order Entry (CPOE), for example. The referring physician typically accesses multiple applications to get all of the information needed before, during and/or after the patient consult and follow-up. For example, in a digital environment, the referring doctor refers to a RIS for results from a current procedure, prior procedures, and/or a web-based image viewer, such as a PACS, for viewing any current and prior images. The doctor may access a CPOE to order any follow-up exams. The referring physician opens the RIS, PACS, and CPOE to search for the information by clicking many tabs and buttons before having access to the information. Thus, there is a need for a system and method which improve searchability and access to data.

Post processing image generation is used by medical professionals to alter images which assist in visualizing and detecting abnormalities in a patient. Post processed images may be necessary for medical professionals to properly and effectively diagnose patients. Currently, post processing image generation is a manual operation which a medical professional performs on various diagnostic x-rays and other imaging techniques such as ultrasound examinations, computerized tomography (CT) examinations, and magnetic resonance imaging (MRI) examinations. Manual post processing image generation can be time consuming and costly, especially in a situation where a patient needs to be scanned periodically and the medical professional has to repeat the process for the same patient regarding the same ailment. A system and method for automatically generating post processed images would improve the efficiency and decrease the costs of manually generating post processed images. Thus, there is a need for a system and method for improving workflow in a healthcare environment using automatic post processing image generation.

### BRIEF SUMMARY OF THE INVENTION

Certain embodiments of the present invention provide system and method for automatic post processing image generation. In an embodiment, the automatic post processing image generation system may include one or more user interfaces, adapted to display one or more images on an image viewer and perform image post processing using one or more image post processing applications. The system may also include one or more storage servers capable of storing user data, wherein the user data includes the one or more images and/or one or more post processing parameters. In addition, the system may include a post processing engine for automatically generating and displaying a current post processed image based on one or more image registration techniques to correlate the one or more post processing parameters of a related previous post processed image with a current image.

Certain embodiments of a method for automatically generating post processed images may include creating an image and identifying a related previous post processed image, the related previous post processed image associated with one or more post processing parameters. The method may also include constructing a post processed image using image registration techniques to correlate the one or more post processing parameters of the related previous post processed image with the image. The method may also include displaying the post processed image.

Certain embodiments of a computer-readable storage medium may include a set of instructions for a computer. In certain embodiments, the set of instructions may include a storage routine for storing an image. The set of instructions may also include an identification routine for automatically identifying a related previous post processed image. In addition, the set of instructions may also include a generation routine for constructing a post processed image using image registration techniques to correlate one or more post processing parameters of the related previous post processed image with the image. The set of instructions may also include a display routine for displaying the post processed image constructed by the generation routine.

### BRIEF DESCRIPTION OF SEVERAL VIEWS OF THE DRAWINGS

FIG. 1 illustrates an automatic post-processing image generation system used in accordance with an embodiment of the present invention.

FIG. 2 illustrates a flow diagram for a method for improving workflow in a healthcare environment using automatic post-processing image generation in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

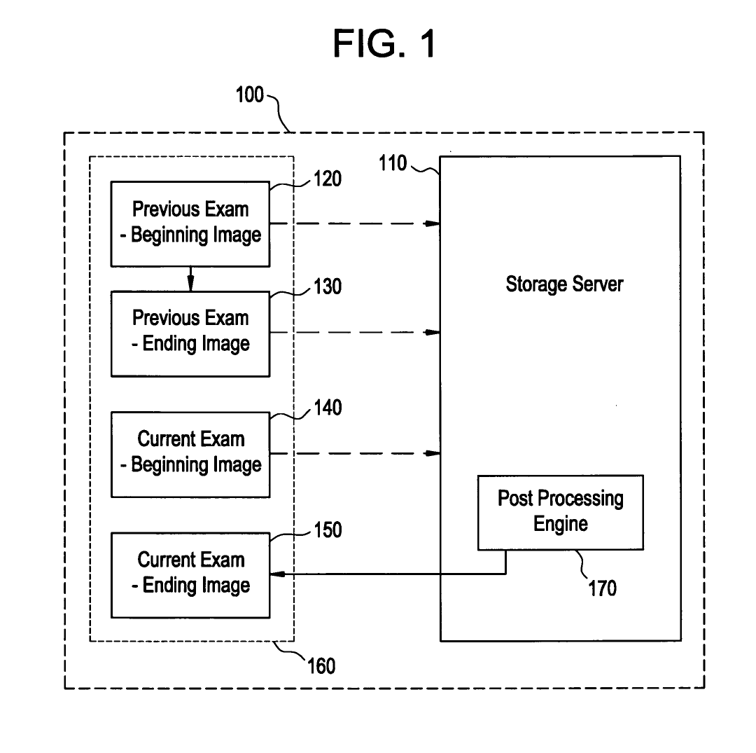

FIG. 1 illustrates an automatic post-processing image generation system 100 used in accordance with an embodiment of the present invention. The system 100 includes a storage server 110, at least one user interface 160, a post processing engine 170, an original previous examination image 120, an altered previous examination image 130, an original current examination image 140, and an automatically altered current examination image 150. The images 120-150 may be stored on the user interface 160 and/or on the storage server 110, which may be a PACS server, a database, a library, or other general memory, among other things. The components of the system 100 may communicate via wired and/or wireless connections on one or more processing units, such as computers, medical systems, storage devices, custom processors, and/or other processing units. The system 100 may be implemented in software and/or hardware. In an embodiment, the automatic post processing image generation system 100 is integrated into a single unit, or may be integrated in various forms.

The system 100 may be used to provide a solution for automatically constructing and displaying post processed images 150 based on previously stored post processing parameters from a previous examination of the same patient. For example, patients who are deemed to be high risk for specific ailments and patients who are undergoing therapy are often scanned periodically to monitor the patients' health. A radiologist, cardiologist, technician, or other hospital staff member that uses medical imaging technology often uses three-dimensional post processing generation applications to generate post processed images based on images created in an examination. These post processed images can offer views of the anatomy that assist a radiologist or other doctor in visualizing and detecting abnormalities. In an embodiment, the system 100 saves the post processing parameters used by the doctor to generate the post processed images 130 and uses those saved post processing parameters to automatically generate similar post processed images 150 after conducting future repeated examinations for the same patient. In an embodiment, examples of post processed images include: multiplanar reformations, curve planar reformations, volume rendered images, fly-through image views, fly-around image views, maximum intensity projections, and minimum intensity projections, among others. Saggital and coronal views, among others, are examples of multiplanar reformation image views in accordance with an embodiment of the present invention. One skilled in the art would recognize that there are many types of post processed images and subsets of views there from. The types of post processed images and any views mentioned are for exemplary purposes and are not intended to limit the present invention.

In an embodiment, the at least one user interface 160 is used by a radiologist or other healthcare professional to, among other things, view and interact with images created as the result of an examination. Images created by a radiologist to accurately read and interpret the results of an examination may include various diagnostic x-rays and other imaging techniques such as ultrasound examinations, computerized tomography (CT) examinations, and magnetic resonance imaging (MRI) examinations, among other things. An image 120, 140 from an examination may be displayed on an image viewer, the image viewer being a program or application on (or accessible to) the user interface 160. While viewing the image 120, 140 from the examination, a radiologist or other healthcare professional may use a post processing application to alter the views of the image 120 or filter out image information in order to locate possible abnormalities in the image 120. The post processing application, which is a program or application on (or accessible to) the user interface 160, may be integrated with the image viewer or a separate application. One example of an integrated image viewer and post processing application would be the AW Workstation. In an embodiment, the user interface 160, may also contain the storage server 110 and/or the post processing engine 170. The post processing engine may be a set of commands, which may be implemented in software and/or hardware on a storage server 110 or user interface 160, such as an AW workstation and/or PACS workstation, or other workstation.

In an embodiment, a storage server 110 is used to save images 120, 140 created from an examination after a radiologist or other healthcare professional performs an examination on a patient. The storage server 110, may also be used to save post processed images 130, 150, which may be generated manually by a radiologist or other healthcare professional, or the storage server 110 may save automatically generated post processed images 150 in accordance with an embodiment of the present invention. Further, post processing parameters, which may be created by a radiologist or other healthcare professional when generating post processed images 130, may be saved to the storage server 110. Alternatively or in addition, defined rules may be used to configure post processing parameters. The storage server 110 may also store the post processing engine 170. The storage server 110 may be integrated with the user interface 160 or be a separate system. In an embodiment, a storage server 110 may be a PACS server.

In an embodiment, the automatic post-processing image generation system 100 uses a post processing engine 170 to automatically generate and display a current post processed image 150 based on one or more image registration techniques to correlate the one or more post processing parameters of a related previous post processed image 130 with a current image 140 from a current examination. For example, a radiologist who has performed multiple examinations on a particular patient may have already used a post processing application to generate one or several post processed images 130 manually, based on the original images 120 from the original examinations. The original examination images 120 and subsequent manually generated post processed images 130 may be stored on a storage server 110 (which may be integrated with the user interface 160 or a separate application). In an embodiment, upon having additional examinations performed on the same patient, the post processing engine 170 (which may be integrated with the user interface 160, the storage server 110, or a separate application) may utilize the post processing parameters saved on the storage server 110 (or alternatively, on the user interface 160 or on the post processing application) from when the radiologist or other healthcare professional manually generated post processed images 130 using the previous original examination images 120, and using image registration techniques and/or other post processing techniques, may automatically generate current post processed images 150.

In an embodiment, image registration techniques are used to properly convert and align images into the appropriate format. Image registration techniques are used to identify and map points in an image 140 to a reference coordinate system and/or other image 130, for example. Image registration techniques may use extrinsic methods (e.g. artificial objects attached to the patient), intrinsic methods (e.g. patient generated image content), and non-image based (e.g. calibrating the equipment used in taking the images), among other things. Examples of intrinsic methods used for image registration techniques may include landmark based techniques (e.g. salient or geometrical), segmentation based techniques (e.g. rigid or deformable model), and voxel based techniques (e.g. operates directly on image gray values), among other things. The one or more image registration technique used to automatically generate post processed images 150 depend on the examination performed and the radiologist or other healthcare professionals choice (or the default in the post processing engine 170).

In an embodiment, post processing parameters are configured by a radiologist or other healthcare professional when manually generating post processed images 130. Rules, preferences, perspectives, and/or other criteria may be used to configure post processing parameters, for example. Subsequently, the post processing parameters used by a radiologist or other healthcare professional in manually generating post processed images 130 may be used by the post processing engine 170, which may use one or more image registration techniques to correlate the one or more post processing parameters of the related previous post processed image 130 with a current image 140 from a recent examination. Examples of post processing parameters may vary depending on what type of post processed image was generated. For example, a volume rendered post processed image uses a new coordinate system (defined by three angle of rotations from an original coordinate system), clipping planes, and an opacity transfer function, among other things. In another example, a maximum intensity projection post processed image uses a new coordinate system (defined by three angle of rotations from an original coordinate system) and a thickness of the new images, among other things. One skilled in the art would be familiar with the wide variety of post processing parameters and techniques that may be used depending on the type of post processed image at issue. The types of post processing parameters mentioned are for exemplary purposes and are not intended to limit the present invention.

In operation, a patient is scanned and an image 120 is created and stored in the storage server 110. The post processing engine 170 in the storage server searches for previous related post processed images 130 but none are found because this is the patient's first examination related to his or her current ailment. A radiologist or other healthcare professional views the image 120 on a user interface 160 using an image viewer or a post processing application with an integrated image viewer. The radiologist or other healthcare professional uses the post processing application to manually generate a post processed image 130. The post processed image 130 is saved to the storage server 110 with the post processing parameters used to create the post processed image 130. Then, when the patient comes in for another scan regarding the same ailment, for example, an examination is conducted and a current image 140 is generated and saved to the storage server 110. The post processing engine 170 does a search and recognizes and locates the previously saved post processed image 130. Next, the post processing engine 170 automatically generates a current post processed image 150 based on image registration techniques to correlate the saved post processing parameters of the related previous post processed image 130 with the current image 140. The automatically generated current post processed image 150 is then saved to the storage server 110 and displayed on the user interface 160 via an image viewer or post processing application with an integrated image viewer.

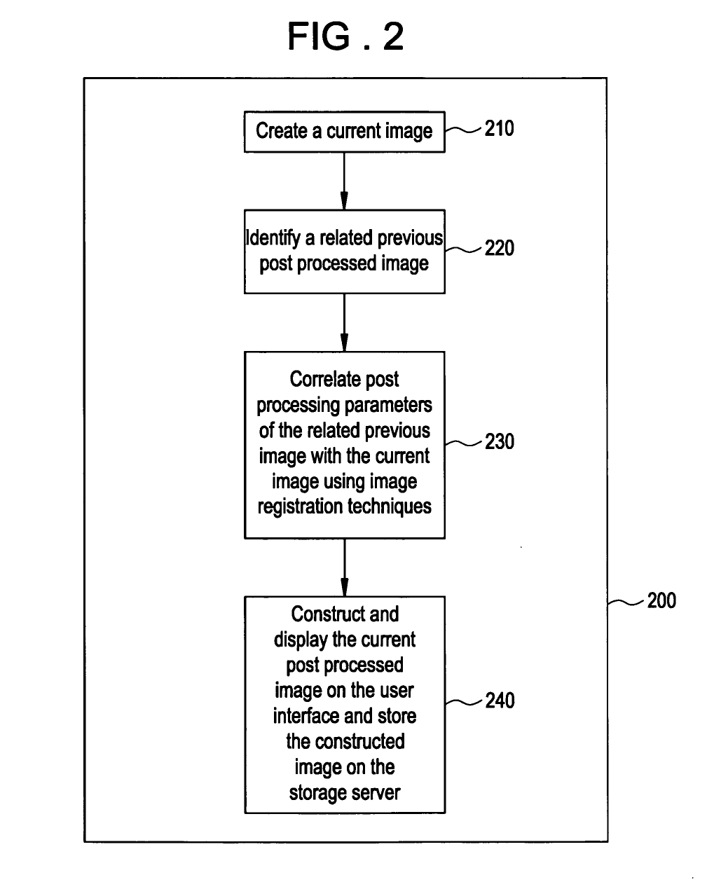

FIG. 2 illustrates a flow diagram for a method 200 for improved workflow in a medical environment by automatically generating post processed images in accordance with an embodiment of the present invention.

First, at step 210, an examination is performed by a radiologist or other healthcare professional that results in an image 120, 140 or group of images being created. For example, a radiologist may perform various diagnostic x-rays and other imaging techniques on a patient such as ultrasound examinations, computerized tomography (CT) examinations, and magnetic resonance imaging (MRI) examinations, among other things.

At step 220, the post processing engine 170, which may be part of the storage server 110, the user interface 160, or a separate entity, for example, identifies any previous related post processed images 130. If the examination performed is on an existing patient who has undergone similar examinations previously, a radiologist or other healthcare professional may have manually generated post processed images 130 based on the previous examination images 120. Previous post processed images 130 may be stored in the storage server 110, for example. In an embodiment, if no previous examinations exist, the post processing engine 170 may have stored default post processing parameters and image registration techniques. Otherwise, if no previous post processed images or post processing parameters and image registration techniques exist, a radiologist or other healthcare professional may have to manually generate post processed images 130 based on the current examination images 120.

Then, at step 230, the post processing engine 170, which may be part of the storage server 110, the user interface 160, or a separate entity, for example, uses image registration techniques to correlate post processing parameters of the identified previous examinations 130 with the current examination 140. One or more image registration techniques are used to properly convert the current examination image 140 and align the current examination image 140 with a previous examination's post processed image 130 so as to display the automatically generated current post processed image 150 in the appropriate format. The one or more image registration techniques used to automatically generate post processed images 150 depend on the examination performed and the radiologist or other healthcare professional's choice (or a default setting in the post processing engine 170). Image registration techniques are important to appropriately align the previous post processed image 130 with the current image 140. The one or more image registration techniques match points on the new image 140 with points on the prior post processed image 130. Image registration techniques may use extrinsic methods, intrinsic methods, and non-image based methods, for example.

The post processing parameters used to automatically generate the current post processed image 150 may be previously created with the previous related post processed image 130 manually created by the radiologist or other healthcare professional and saved on the storage server 110 (or on the user interface 160 or with the post processing application on the user interface 160), for example. Alternatively, the post processing parameters may be defaults set with the post processing engine 170. Post processing parameters may vary depending on what type of post processed image was generated (see examples above).

Next, at step 240, the post processing engine 170, which may be part of the storage server 110, the user interface 160, or a separate entity, for example, constructs and displays the current post processed image 150 in an image viewer (or post processing application with integrated image viewer) on the user interface 160 and saves the current post processed image 150 on the storage server 110. Thus, the user is automatically presented with relevant images 150 based on a previous examination of the patient. The images 150 may be displayed for the user, stored, and/or routed to another program, for example. In an embodiment, the image 150 may be stored on the user interface 160, with an application on the user interface 160 (such as the image viewer or post processing application, for example), and/or on the storage server 110, among other things.

Thus, certain embodiments accelerate the user's workflow and increase a user's productivity by automatically generating post processed images. Increased productivity includes a speed in which a diagnosis may be performed and an accuracy of reports produced based on the diagnosis.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. An automatic post processing image generation system, the system comprising:
at least one user interface, adapted to:
display at least one image on an image viewer, and
perform image post processing using at least one image post processing application;
at least one storage server capable of storing user data, wherein the user data includes at least one of:
said at least one image, and
at least one post processing parameter; and
a post processing engine for automatically generating and displaying a current post processed image based on an at least one image registration technique to correlate said at least one post processing parameter of a related previous post processed image with a current image.

2. The system of claim 1, wherein said post processing engine uses said at least one post processing parameter to generate said current post processed image in at least one of:
a multiplanar reformation,
a curve planar reformation,
a volume rendered image,
a fly-through image views,
a fly-around image views,
a maximum intensity projection, and
a minimum intensity projection.

3. The system of claim 1, wherein said at least one image post processing application is a three-dimensional post processing generation application.

4. The system of claim 1, wherein said at least one storage server is a Picture Archiving and Communication System (PACS) server.

5. The system of claim 1, wherein said post processing engine is integrated in said storage server.

6. The system of claim 1, wherein said at least one post processing parameter includes at least one of:
a coordinate system,
an opacity transfer function,
at least one clipping plane, and
a thickness of the new images.

7. The system of claim 1, wherein said at least one image registration technique includes at least one of:
at least one extrinsic method,
at least one intrinsic method, and
at least one non-image based method.

8. The system of claim 7, wherein said at least one intrinsic method includes at least one of:
at least one landmark based registration method,
at least one segmentation based registration method, and
at least one voxel based property registration method.

9. A method for automatically generating a post processed image, the method comprising:
creating an image;
identifying a related previous post processed image, said related previous post processed image associated with at least one post processing parameter;
constructing a post processed image using image registration techniques to correlate said at least one post processing parameter of said related previous post processed image with said image; and
displaying said post processed image.

10. The method of claim 9, further comprising storing said image and said post processed image on a storage server.

11. The method of claim 10, wherein said related previous post processed image is identified on said storage server.

12. The method of claims 11, wherein said storage server is a Picture Archiving and Communication System (PACS) server.

13. The method of claim 9, wherein said related previous post processed image and said post processed image are three dimensional images.

14. The method of claim 9, wherein the process of identifying said related previous post processed image, constructing said post processed image, and displaying said post processed image is dynamic.

15. The method of claim 9, wherein said at least one post processing parameter of said related previous post processed image causes said post processed image to be constructed and displayed in at least one of:
a saggital view, and
a coronal view.

16. The method of claim 9, wherein said at least one post processing parameter is saved on at least one of:
a storage server,
a user interface,
an image post processing application, and
said related previous post processed image.

17. The method of claim 9, wherein said at least one image registration technique includes at least one of:
at least one extrinsic method,
at least one intrinsic method, and
at least one non-image based method.

18. The method of claim 17, wherein said at least one intrinsic method includes at least one of:
at least one landmark based registration method,
at least one segmentation based registration method, and
at least one voxel based property registration method.

19. A computer-readable storage medium including a set of instructions for a computer, the set of instructions comprising:
a storage routine for storing an image;
an identification routine for automatically identifying a related previous post processed image;
a generation routine for constructing a post processed image using image registration techniques to correlate at least one post processing parameter of said related previous post processed image with said image; and
a display routine for displaying said post processed image constructed by said generation routine.

20. The set of instructions of claim 19, further comprising a post processing routine for performing post processing on said image if no said related previous post processed image exists.
